(19) United States
(12) Patent Application Publication
(10) Pub. No.: US 2024/0332964 A1
(43) Pub. Date: Oct. 3, 2024

(54) VEHICLE POWER MONITORING AND AUXILIARY STARTING DEVICE

(71) Applicants: Tao-Yi Huang, New Taipei City (TW); Te-Liang Shen, New Taipei City (TW); Tzu-Hsuan Shen, New Taipei City (TW)

(72) Inventors: Tao-Yi Huang, New Taipei City (TW); Te-Liang Shen, New Taipei City (TW); Tzu-Hsuan Shen, New Taipei City (TW)

(21) Appl. No.: 18/128,229

(22) Filed: Mar. 30, 2023

(51) Int. Cl. H02J 1/10; B60R 16/033; H02J 1/08; H02J 7/00; H02J 7/34

(52) U.S. Cl. CPC H02J 1/122; B60R 16/033; H02J 1/084; H02J 7/0048; H02J 7/0063; H02J 7/345

(57) ABSTRACT

A vehicle power monitoring and auxiliary starting device is provided. The device includes a case, a supercapacitor module, a first circuit, and a second circuit. The at least one supercapacitor module is connected in series through the first circuit, the second circuit includes a balanced charging and controlling circuit, a display module, a relay control circuit and a boost circuit. The first circuit has a positive pole and a negative pole connected with the vehicle battery's positive pole and negative pole. The power of the vehicle battery maintains a certain amount of reserve power, and the balanced charging and controlling circuit of the second circuit monitor the vehicle battery.

### FIELD OF THE DISCLOSURE

The present disclosure relates to A vehicle power monitoring and auxiliary starting device, and more particularly to a device with an auxiliary supercapacitor module, equipped with a circuit to detect the state of the electric quantity signal of the vehicle battery. Through a relay control circuit controlling a relay, the electrical connection between the supercapacitor module and the vehicle battery can be disconnected or connected to achieve the device design for vehicle power monitoring and auxiliary starting.

### BACKGROUND OF THE DISCLOSURE

In recent years, the automobile industry has developed rapidly, and various electronic equipment for automobiles is also available. Therefore, due to the addition of electronic equipment in automobiles, the overall power consumption has increased. For example, navigation systems, automatic driving, automatic emergency braking (AEB), electronic sliding doors, electronic trunk, stereo, driving recorder, tire pressure detector, blind spot detection, head-up display, sub-package charging system, ambient car light, sensor wiper, etc., are all devices that consume power. Therefore, the battery load is also relatively increased.

Furthermore, the battery's efficiency will be greatly affected in a high-temperature or low-temperature environment, especially when the temperature rises or falls due to climate change. In addition, the current new vehicles are equipped with a lot of electronic equipment, which will also reduce the space in the engine room, the temperature in the engine room rises, and the life of the battery rapidly declines, resulting in poor storage efficiency. Finally, the vehicle can no longer be started.

In addition, the charging time is insufficient due to the vehicle is often driven only for a short distance or the vehicle is parked for a long time so that the battery power is exhausted by various electronic devices in the car, which are the reasons that the battery power is insufficient, and the vehicle cannot be started.

At present, there is electric storage and starting products on the market for the situation when the vehicle's battery is too low. Still, the electric storage products on the market include the starting battery and the electric storage part. The original battery of the vehicle must be removed before installation and switched to the entire set of equipment. This way, it costs more money and limits the consumer when the product is damaged. The product repair may be limited to the original manufacturer or to purchase another replacement product.

Further, regarding another commercially available power storage product. The power storage product does not require removing the original vehicle battery. It has a wireless system to display the status of the vehicle battery on the application of the driver's mobile device. When the vehicle battery's state is abnormal, the driver will issue instructions through the application program to control the disconnection or connection between the power storage product and the vehicle battery. However, although this design is convenient, it is believed that ordinary people will only sometimes click on the application (app) program to check the status of the vehicle battery. The vehicle battery is usually normal, but the abnormality only occurs in special circumstances. Therefore, it is unlikely for the driver to check the app for the vehicle battery status frequently, and it also causes a burden on the driver. The abnormality of the vehicle battery as mentioned above, usually occurs inadvertently. Further, the structure of the power storage product is complicated, which increases the cost and the relative price and needs to be more practical.

### SUMMARY OF THE DISCLOSURE

In view of the practical difficulties and deficiencies to be improved in the above-mentioned conventional vehicle power storage products, a device is in need to enhance the conventional art. The present disclosure provides A vehicle power monitoring and auxiliary starting device for users, built up by the professional technical knowledge and practical experience of design, production, and business experience, as well as research and design results.

The present disclosure provides A vehicle power monitoring and auxiliary starting device is provided. The device includes a case, a supercapacitor module, a first circuit, and a second circuit. In which, the supercapacitor module is disposed in the case, the supercapacitor module includes at least one supercapacitor, and the first circuit is disposed on the supercapacitor module. The supercapacitor module and the first circuit are connected in series, the first circuit and the second circuit are electrically connected. The supercapacitor module includes a balanced charging and controlling circuit, a display module, a relay control circuit, and a boost circuit. The first circuit has a positive pole and a negative pole connected with the vehicle battery's positive and negative poles in parallel, respectively. The power of the vehicle battery maintains a certain amount of reserve power, and the balanced charging and controlling circuit of the second circuit monitor the vehicle battery.

In one aspect, when the vehicle battery is old and has poor power storage efficiency or the vehicle has been parked for a long time that the battery power is too low to start the vehicle, the balanced charging and controlling circuit of the second circuit detects a signal state and turns off the relay by the relay control circuit, so that the electrical connection between the supercapacitor module and the vehicle battery is temporarily disconnected to maintain the stored power of the supercapacitor module without causing the reserve power of the supercapacitor to flow to the vehicle battery and be consumed or exhausted. Therefore, in the situation that the vehicle battery is insufficient to start the engine, by pressing the switch on the device, the relay control circuit will force the relay to be turned on, so that the positive pole and the negative pole of the supercapacitor module connect to the positive pole and the negative pole of the vehicle battery, and the vehicle engine can be started by the reserve power in the supercapacitor module.

In another aspect, when the vehicle has been parked for a long time that the battery power too low to start the vehicle, the balanced charging and controlling circuit of the second circuit detects a signal state and turns off the relay by the relay control circuit, so that the electrical connection between the supercapacitor module and the vehicle battery is temporarily disconnected. Even if the reserve power of the supercapacitor module is lower than the standard to start the vehicle, a power bank or an external power supply can be applied, and the TYPE-C charging port and the boost circuit are used for speedy charging the supercapacitor module. When the reserve power of the supercapacitor module is enough to start the vehicle, the switch is pressed to allow the relay control circuit to turn on the relay, the positive pole and the negative pole of the supercapacitor module connect to the positive pole and the negative pole of the vehicle battery and the vehicle engine can be started by the reserve power.

The display module of the second circuit is used to display the level of the reserve power of the supercapacitor module.

The present disclosure provides a device that disconnects the electrical connection between the supercapacitor module and the vehicle battery opportunely to maintain the reserve power of the supercapacitor when the power of the vehicle battery is too low to start the vehicle. Through pressing the switch, the relay control circuit will force the relay to be turned on, so that the positive pole and the negative pole of the supercapacitor module connect to the positive pole and the negative pole of the vehicle battery, and the vehicle engine can be started by the reserve power in the supercapacitor module. The device is easy to use and low-cost.

In another aspect, the second circuit includes a TYPE-C charging port, and the supercapacitor module can be charged through the boost circuit of the second circuit, to solve the problem of starting the vehicle engine.

In another aspect, the display module of the second circuit is used to display the level of the reserve power of the supercapacitor module, which allows the driver to be accurately aware of the power of the supercapacitor module, and decide whether to charge the supercapacitor module.

### BRIEF DESCRIPTION OF THE DRAWINGS

The described embodiments may be better understood by reference to the following description and the accompanying drawings in which:

FIG. 1 is an exploded perspective schematic view of an embodiment of the device of the present disclosure;

FIG. 2 is a perspective schematic view of the device of the present disclosure; and

FIG. 3 is a block diagram of the device of the present disclosure.

### DETAILED DESCRIPTION OF THE EXEMPLARY EMBODIMENTS

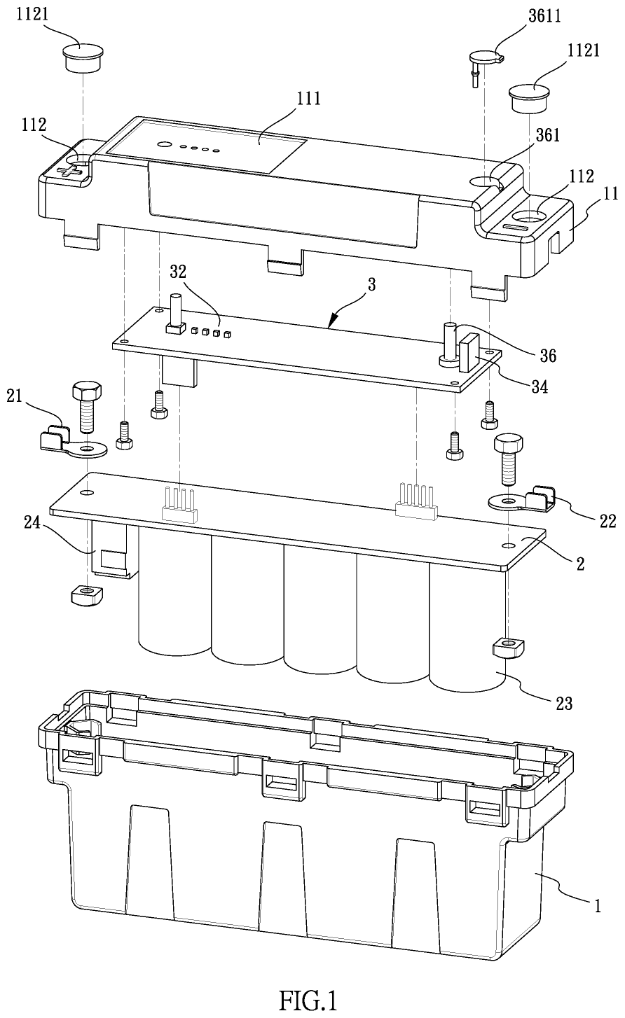

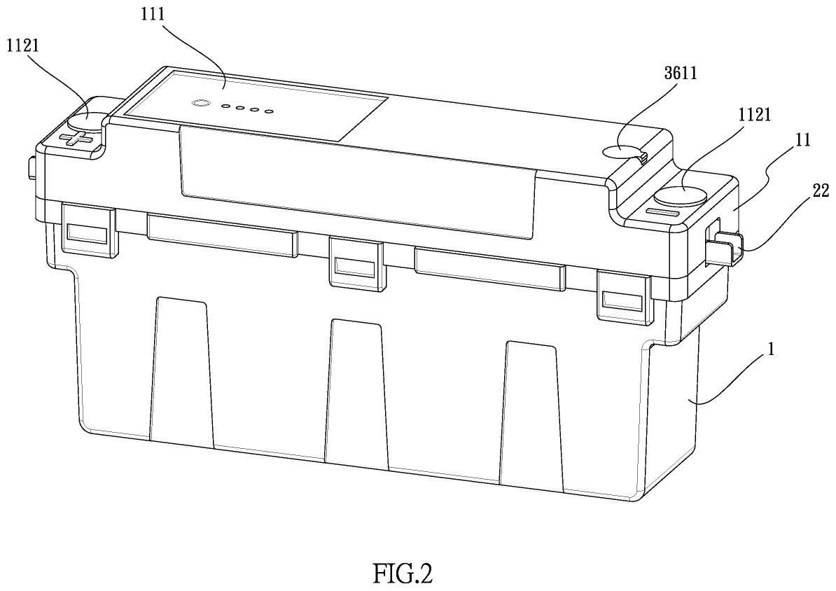

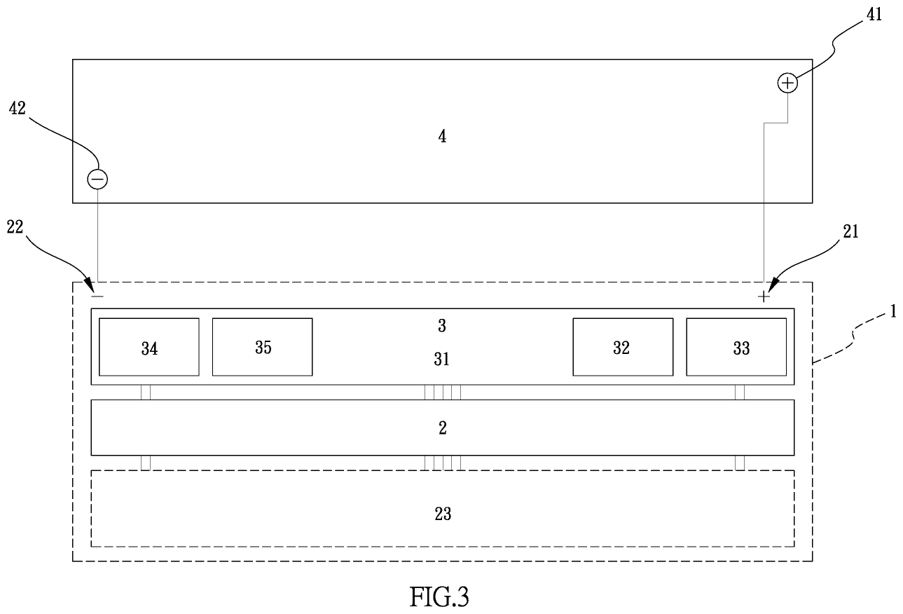

Referring to FIG. 1, FIG. 2, and FIG. 3, the present disclosure provides A vehicle power monitoring and auxiliary starting device is provided. The device includes a case 1, a supercapacitor module 23, a first circuit 2, and a second circuit 3. The supercapacitor module 23 is disposed in the case 1, the supercapacitor module 23 includes at least one supercapacitor, and the first circuit 2 is disposed on the supercapacitor module 23. The supercapacitor module 23 is connected in series through the first circuit 2, the first circuit 2 and the second circuit 3 are electrically connected, the second circuit 3 includes a balanced charging and controlling circuit 31, a display module 32, an relay control circuit 33, and a boost circuit 35. The first circuit 2 has a positive pole 21 and a negative pole 22 connected with a positive pole 41 and a negative pole 42 of the vehicle battery 4 in parallel, respectively. The first circuit 2 has a relay 24 controlled by the relay control circuit 33. The power of the vehicle battery 4 maintains a certain amount of reserve power in the supercapacitor module 23, and the balanced charging and controlling circuit 31 of the second circuit 3 monitor the vehicle battery 4. In one embodiment, when the vehicle battery 4 is old and has poor power storage efficiency or the vehicle has been parked for a long time that the vehicle battery 4 power is too low to start the vehicle engine, the balanced charging and controlling circuit 31 of the second circuit 3 detects a signal state and turns off the relay 24 by the relay control circuit 33, so that the electrical connection between the supercapacitor module 23 and the vehicle battery 4 is temporarily disconnected to maintain the reserve power of the supercapacitor module 23 without causing the reserve power of the supercapacitor to flow to the vehicle battery 4 and be consumed or exhausted. When the power of the vehicle battery 4 is too low to start the engine, by pressing the switch 36 on the second circuit 3, the relay control circuit 33 will force the relay 24 to be turned on, so that the positive pole 21 and the negative pole 22 of the supercapacitor module 23 are connected to the positive pole 41 and the negative pole 42 of the vehicle battery 4, and the vehicle engine can be started by the reserve power in the supercapacitor module 23.

In another embodiment, when the vehicle battery 4 is old or the vehicle has been parked for a long time that the battery 4 power is too low to start the vehicle engine, the balanced charging and controlling circuit 31 of the second circuit 3 detects a signal state and turns off the relay 24 by the relay control circuit 33, so that the electrical connection between the supercapacitor module 23 and the vehicle battery 4 is temporarily disconnected. Even the reserve power of the supercapacitor module 23 is lower than the standard for starting the vehicle's engine. A power bank or an external power supply can be applied. The supercapacitor module 23 can be charged through the TYPE-C charging port 34 and boost circuit 35 of the second circuit 3 until the reserve power of the supercapacitor module 23 can start the vehicle engine. By pressing the switch 36 on the device, the relay control circuit 33 will force the relay 24 to be turned on, so that the positive pole 21 and the negative pole 22 of the supercapacitor module 23 are connected to the positive pole 41, and the negative pole 42 of the vehicle battery 4, and the vehicle engine can be started by the reserve power in the supercapacitor module 23.

The display module 32 of the second circuit 3 is used to display the level of the reserve power of the supercapacitor module 23.

Further, the case 1 has an upper cover 11 on the top, the case 1 and the upper cover 11 are airtight and waterproof. Each of two ends of the upper cover 11 has locking holes 112 and the two locking holes are arranged correspondingly to the positive pole 21 and the negative pole 22 of the first circuit 2. Each of the locking holes 112 has a first waterproof stopper 1121 corresponding to the locking hole 112. The upper cover 11 has a through hole 361 and second waterproof stoppers 3611 corresponding to the switch 36. The upper cover 11 has a viewing hole 111 for displaying the power level.

The device of the present disclosure includes at least one supercapacitor of the supercapacitor module 23, and provides the electrical connection between the vehicle battery 4 and the supercapacitor module 23. The supercapacitor has the functions of charging and discharging, rectification, oscillation, voltage stabilization, etc. It can be mainly used in power supply circuits to realize the functions of bypass, decoupling, filtering, energy storage, and voltage stabilization. Therefore, using the supercapacitor module 23, the supercapacitor module 23 can assist and stabilize the voltage of the vehicle battery 4 in supplying and transmitting power to related electronic equipment and engines in the vehicle. In addition, when the vehicle battery 4 is assisted by the supercapacitor module 23, it can not only stabilize the voltage of the power output, but also optimal for supplying power to each electronic device due to the voltage stability, which results in the purpose of saving fuel for the whole vehicle. In other words, when the output of various electronic devices is stable, the vehicle can greatly reduce the loss of fuel consumption during operation. Therefore, the supercapacitor module 23 allows the vehicle battery 4 to stabilize the voltage on the power supply and transmission, and further achieve the purpose of fuel saving based on stable voltage.

In summary, the device of the present disclosure provides the advantages that the device is easy to use and low cost. The electrical connection between the supercapacitor module 23 and the vehicle battery 4 can be disconnected opportunely to maintain the reserve power of the supercapacitor module 23. By pressing the switch 36 on the device, the relay control circuit 33 will force the relay 24 to be turned on, and the vehicle engine can be started by the reserve power in the supercapacitor module 23.

What is claimed is:

1. A vehicle power monitoring and auxiliary starting device, comprising: a case, a supercapacitor module, a first circuit, and a second circuit;
wherein, the supercapacitor module is disposed in the case, the supercapacitor module includes at least one supercapacitor, the first circuit is disposed on the supercapacitor module; the supercapacitor module and the first circuit are connected in series, the first circuit and the second circuit are electrically connected; wherein, the second circuit includes a balanced charging and controlling circuit, a display module, a relay control circuit, a TYPE-C charging port and a boost circuit; wherein the first circuit has a positive pole and a negative pole connected with a positive pole and a negative pole of a vehicle battery in parallel respectively; wherein the first circuit has a relay controlled by the relay control circuit;
wherein the power of the vehicle battery maintains a certain amount of reserve power in the supercapacitor module, and the balanced charging and controlling circuit of the second circuit monitor the vehicle battery;
wherein when the vehicle battery power is too low to start the vehicle engine, the balanced charging and controlling circuit of the second circuit detects a signal state and turns off the relay by the relay control circuit, so that the electrical connection between the supercapacitor module and the vehicle battery is temporarily disconnected to maintain the stored power of the supercapacitor module without causing the reserve power of the supercapacitor to flow to the vehicle battery and be consumed or exhausted; wherein through pressing a switch on the second circuit, the relay control circuit will force the relay to be turned on, so that the positive pole and the negative pole of the supercapacitor module connect to the positive pole and the negative pole of the vehicle battery, and the vehicle engine can be started by the reserve power in the supercapacitor module; wherein the display module of the second circuit is used to display the level of reserve power of the supercapacitor module.

2. The vehicle power monitoring and auxiliary starting device according to claim 1, wherein when the reserve power of the supercapacitor module is lower than the standard to start the vehicle engine, a power bank or an external power supply can be applied, wherein the TYPE-C charging port and the boost circuit are used for charging the supercapacitor module, when the reserve power of the supercapacitor module is enough to start the vehicle, the switch is pressed to allow the relay control circuit turning on the relay, the positive pole and the negative pole of the supercapacitor module are connected to the positive pole and the negative pole of the vehicle battery and the vehicle engine can be started by the reserve power.

3. The vehicle power monitoring and auxiliary starting device according to claim 1, wherein the case has an upper cover, the case and the upper cover are airtight and waterproof; wherein each of two ends of the upper cover has a locking hole, and the two locking holes are arranged correspondingly to the positive pole and the negative pole of the first circuit; wherein each of the locking holes has a first waterproof stopper corresponding to the locking hole.

4. The vehicle power monitoring and auxiliary starting device according to claim 3, wherein the upper cover has a through holes and a second waterproof stopper corresponding to the switch.

5. The vehicle power monitoring and auxiliary starting device according to claim 3, wherein the upper cover has a viewing hole corresponding to the display module to display the level of reserve power.
